(19) United States
(12) Patent Application Publication
(10) Pub. No.: US 2025/0303766 A1
(43) Pub. Date: Oct. 2, 2025

(54) IMAGE FORMING SYSTEM

(71) Applicant: CANON KABUSHIKI KAISHA, Tokyo (JP)

(72) Inventors: FUMIHIKO HAYAYUMI, Chiba (JP); OSAMU SATO, Tokyo (JP)

(21) Appl. No.: 19/096,081

(22) Filed: Mar. 31, 2025

(30) Foreign Application Priority Data
Apr. 2, 2024 (JP) 2024-059674
Dec. 3, 2024 (JP) 2024-209951

(51) Int. Cl. B41J 29/377; B41J 29/13; B41J 29/393; G03G 15/00; G03G 21/16; G03G 21/20

(52) U.S. Cl. CPC B41J 29/377; B41J 29/13; B41J 29/393; G03G 15/80; G03G 21/1633; G03G 21/206; G03G 2221/1645

(57) ABSTRACT

An image forming system includes a plurality of modules, the image forming system includes a first module, a second module, the first module and the second module being arranged along a conveying direction in which a sheet in the first module is conveyed, a first electric component module coupled to the first module, the first electric component module being arranged, with respect to the first module, in a crossing direction that intersects the conveying direction, a first electric component unit provided in the first module, and a duct arranged below the first electric component unit in a vertical direction, the duct being configured to guide air for cooling the first electric component unit, wherein the first electric component module has an intake through which the air is sucked into inside the first electric component module.

### BACKGROUND

### Field

The present disclosure relates to an image forming system for forming an image on a recording material by using an ink-jet system or an electrophotographic system.

### Description of the Related Art

Along with an increase in productivity, image quality, stability, lifetime, and functionality in an image forming system, electric power consumed in an apparatus tends to be increased. Along with the increase in power consumption, the amount of heat generated in an electric component portion in the image forming system also increases. Accordingly, an airflow may be provided inside of the image forming system for cooling and heat dissipation of the electric component portion. In U.S. Pat. No. 11,675,310, there is described a configuration in which an airflow for efficiently cooling an electric component unit including a board is provided on a rear surface side of the apparatus.

An airflow for cooling the board of the electric component portion may collect floating matters such as paper powder and dust and blow the floating matters to the board depending on an intake position and an airflow path. The floating matters blown as described above cause a risk of short-circuit in the electric component portion to reduce the reliability of the system. In Japanese Patent Application Laid-open No. 2011-107511, there is described an image forming apparatus in which an electric component board is cooled while floating matters such as paper powder and dust are reduced by a duct provided in the middle of an airflow path. In Japanese Patent Application Laid-open No. 2010-176149, there is described an image forming apparatus including a dust filter provided on an external-air intake side of a fan for cooling a power supply unit, to thereby prevent entry of conductive dust or the like.

Incidentally, as disclosed in Japanese Patent Application Laid-open No. 2022-88820, an image forming system to be used in commercial printing or the like may be formed of a combination of a plurality of modules having different functions. In a case where the plurality of modules is coupled, a connection interface is formed so that an airflow of each module can be established in the coupled state.

### SUMMARY OF THE INVENTION

An image forming system according to some embodiments includes a plurality of modules, the image forming system includes a first module, a second module, the first module and the second module being arranged along a conveying direction in which a sheet in the first module is conveyed, a first electric component module coupled to the first module, the first electric component module being arranged, with respect to the first module, in a crossing direction that intersects the conveying direction, a first electric component unit provided in the first module, and a duct arranged below the first electric component unit in a vertical direction, the duct being configured to guide air for cooling the first electric component unit, wherein the first electric component module has an intake through which the air is sucked into inside the first electric component module, and wherein the duct has a duct opening through which the air passes, wherein a first air path is formed in the first electric component module so that the air sucked through the intake of the first electric component module flows to the duct opening.

Further features of the present disclosure will become apparent from the following description of exemplary embodiments (with reference to the attached drawings).

### BRIEF DESCRIPTION OF THE DRAWINGS

FIG. 1 is a configuration view for illustrating an ink-jet recording system.

FIG. 2 is a perspective view for illustrating the ink-jet recording system as viewed from an upper front side.

FIG. 3 is a perspective view for illustrating the ink-jet recording system as viewed from an upper rear side.

FIG. 4 is a detailed perspective view for illustrating a drying module and an external electric component module as viewed from the upper rear side.

FIG. 5 is a perspective view for illustrating the drying module in a state without the external electric component module as viewed from the upper rear side.

FIG. 6 is an explanatory diagram for illustrating a connection relationship of electric component modules.

FIG. 7 is an enlarged view of cross sections of a duct and a peripheral part thereof as viewed from diagonally above.

FIG. 8 is an explanatory view for illustrating a connection configuration of a related-art ink-jet recording system.

FIG. 9 is a cross-sectional view for illustrating the drying module.

FIG. 10 is an explanatory view for illustrating a configuration in which connection cables are wired inside of a casing of the drying module.

FIG. 11 is a configuration view for illustrating a main control board and a board support.

FIG. 12 is a cross-sectional view for illustrating the drying module.

FIGS. 13A and 13B are detailed configuration views for illustrating the drying module and the external electric component module.

FIGS. 14A and 14B are configuration views for illustrating the external electric component module.

FIGS. 15A and 15B are configuration views for illustrating the drying module.

FIG. 16 is an enlarged cross-sectional view for illustrating an air path.

FIGS. 17A and 17B are detailed configuration views for illustrating a fixing module and an external electric component module.

FIGS. 18A and 18B are configuration views for illustrating the external electric component module.

FIGS. 19A and 19B are configuration views for illustrating the fixing module.

FIG. 20 is an enlarged cross-sectional view for illustrating an air path.

### DESCRIPTION OF THE EMBODIMENTS

Now, referring to the accompanying drawings, description is given of various exemplary embodiments, features, and aspects of the present disclosure.

In an image forming system formed of a combination of a plurality of modules, when independent airflows in which airflows of the respective modules do not interfere with each other are to be formed, each of the modules may include a fan and a duct for forming intake and exhaust ports and the airflow. In this case, there is a fear in that intake and exhaust efficiencies may be reduced due to restrictions in arrangement of the intake and exhaust ports and restrictions in apparatus size. Meanwhile, when the airflows are formed under a state in which the plurality of modules is coupled and integrated, the intake and exhaust ports and the airflow paths can be shared so that the efficiency is improved. However, in many cases, conditions such as temperature, humidity, mixture of foreign matters, and the like do not match among the modules having different functions, and it is difficult to establish an airflow configuration with conditions having the satisfaction of the respective modules.

In particular, in a case where modules including electric component portions are to be coupled, it becomes difficult to arrange supply and exhaust ports of an airflow for cooling the electric component portion, in particular, to secure an intake port and an intake path. The reason is as follows. The electric component portion is often arranged on the module rear side in consideration of maintenance, and, in a case where another module is arranged and coupled on the further rear side of the module, the electric component portion on the module rear side is arranged to be sandwiched between the modules.

In a case where the intake port is secured in the own module, for example, the electric component portion on the module rear side can be cooled through use of ventilation air of a sheet conveyance path taken in from the apparatus front side. In this case, air including floating matters such as paper powder is blown to the electric component portion.

In order to remove the floating matters, measures as described in Japanese Patent Application Laid-open No. 2011-107511 and Japanese Patent Application Laid-open No. 2010-176149 can be used. However, in the configuration of Japanese Patent Application Laid-open No. 2010-176149, although the floating matters can be reduced, dust-proof measures are insufficient for an image forming system to be used in commercial printing in which high reliability, high durability, and long lifetime are expected. The floating matters can be sufficiently removed in a case where the dust filter as described in Japanese Patent Application Laid-open No. 2022-88820 is used. However, in consideration of maintenance work (cleaning and replacement) of the dust filter, it is inappropriate to incorporate the dust filter into an inter-module connection portion present inside of the apparatus.

Some embodiments of the present disclosure provide an image forming system including a highly-reliable airflow configuration using intake air having few floating matters while a cooling effect is maintained.

### First Embodiment

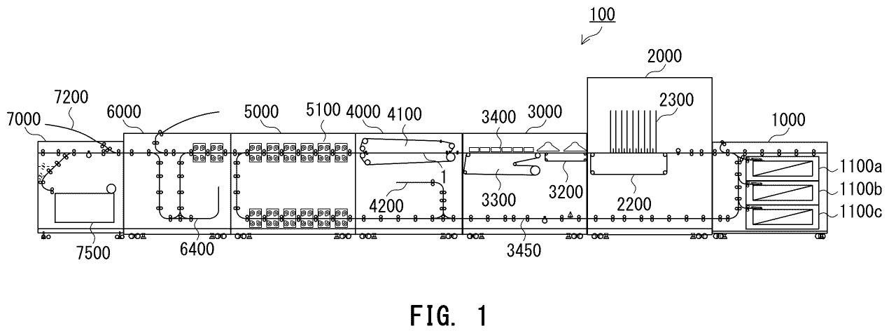

FIG. 1 is a configuration view for illustrating an ink-jet recording system 100 according to an exemplary embodiment. The ink-jet recording system 100 according to this embodiment is a sheet-fed image forming system that forms an ink image on a sheet using two liquids, specifically, a reaction liquid and an ink to produce a product. In this embodiment, a side on which a user stands at the time of operating the ink-jet recording system 100 is referred to as “front side”, and a side opposite to the front side is referred to as “rear side”. A “right-left direction” in a case where the user standing on the front side of the ink-jet recording system 100 sees the ink-jet recording system 100 is a main conveying direction of a sheet in each module. A direction connecting the “front side” and the “rear side” is a “crossing direction” crossing with the sheet conveying direction. The “crossing direction” is sometimes referred to as “front-rear direction”.

The ink-jet recording system 100 includes a sheet feeding module 1000, a printing module 2000, a drying module 3000, a fixing module 4000, a cooling module 5000, a reversing module 6000, and a sheet discharging and stacking module 7000. The sheet feeding module 1000, the printing module 2000, the drying module 3000, the fixing module 4000, the cooling module 5000, the reversing module 6000, and the sheet discharging and stacking module 7000 are arranged side by side in the sheet conveying direction (or along the sheet conveying direction). A sheet being a cut paper-like recording medium on which an image is to be printed is fed from the sheet feeding module 1000, subjected to predetermined processing related to image formation by each module, and discharged to the sheet discharging and stacking module 7000.

The sheet feeding module 1000 includes a plurality of sheet storage portions 1100a to 1100c (three tiers in this embodiment). Each of the sheet storage portions 1100a to 1100c can store sheets therein. Each of the sheet storage portions 1100a to 1100c is configured to be capable of being drawn toward a front side of the apparatus, and sheets are stored in each sheet storage portion after the sheet storage portion is drawn toward the front side of the apparatus. The sheet feeding module 1000 feeds sheets one by one to the printing module 2000. Thus, each of the sheet storage portions 1100a to 1100c includes a separation belt and conveyance rollers. The number of the sheet storage portions 1100a to 1100c is an example, and may be one, two, or four or more.

The printing module 2000 forms an image on a sheet fed from the sheet feeding module 1000. The printing module 2000 includes a pre-image-forming registration correction unit (not shown), a print belt unit 2200, and a recording unit 2300. The pre-image-forming registration correction unit corrects an inclination and a position of the sheet fed from the sheet feeding module 1000, and conveys the sheet to the print belt unit 2200.

The print belt unit 2200 and the recording unit 2300 are arranged on a downstream side of the pre-image-forming registration correction unit in a sheet conveying direction so as to be opposed to each other across a sheet conveyance path. The print belt unit 2200 conveys, through suction, a sheet to be conveyed from the pre-image-forming registration correction unit. The recording unit 2300 is a sheet processing unit that performs recording processing (printing) from above by a recording head to form an image on the sheet conveyed by the print belt unit 2200. The recording head performs printing by ejecting the ink onto the sheet. The sheet is conveyed through suction by the print belt unit 2200, and thus a constant clearance between the recording head and the sheet is maintained.

A plurality of recording heads is arranged along the sheet conveying direction. The recording heads in this embodiment are five line-type recording heads corresponding to four colors of Y (yellow), M (magenta), C (cyan), and K (black), and the reaction liquid. The number of colors and the number of recording heads are not limited to five. As the ink-jet system, a system using a heat generating element, a piezoelectric element, an electrostatic element, or a micro-electro-mechanical-system (MEMS) element can be adopted. The ink of each color is supplied to the recording head from an ink tank (not shown) through an ink tube.

The sheet printed in the recording unit 2300 is conveyed by the print belt unit 2200. An in-line scanner (not shown) is arranged on a downstream side of the recording unit 2300 in the conveying direction. The in-line scanner is used in order to detect misalignment and color density of the image formed on the sheet and to correct an image to be printed.

The drying module 3000 dries the sheet on which the image has been formed by the printing module 2000. The drying module 3000 dries the sheet to reduce a liquid component contained in the ink, thereby improving fixability between the sheet and the ink. The drying module 3000 includes a decoupling unit 3200, a drying belt unit 3300, and a warm air blowing unit 3400.

The sheet printed in the recording unit 2300 of the printing module 2000 is conveyed to the decoupling unit 3200 in the drying module 3000. The decoupling unit 3200 weakly holds and conveys the sheet by air pressure from above and belt friction. This prevents displacement of the remaining portion of the sheet on the print belt unit 2200 under a state in which the sheet extends astride the decoupling unit 3200 and the print belt unit 2200.

The sheet conveyed from the decoupling unit 3200 is conveyed through suction to the drying belt unit 3300, and at the same time, hot air is blown to the sheet from the warm air blowing unit 3400 arranged above the belt to dry the ink application surface (image printed surface). In addition to the hot air blowing method, the drying method may include a combination of a method of irradiating the sheet surface with electromagnetic waves (such as ultraviolet rays and infrared rays) and a conduction heat transfer method through contact of heating elements.

The fixing module 4000 fixes the image on the sheet by heating the sheet dried in the drying module 3000 and by drying the ink. The fixing module 4000 includes a fixing belt unit 4100 including an upper belt unit and a lower belt unit. The fixing module 4000 causes the sheet conveyed from the drying module 3000 to pass between the heated upper belt unit and lower belt unit, and thus causes (fixes) the ink solvent to fully permeate the sheet.

The cooling module 5000 cools the sheet on which the image has been fixed by the fixing module 4000, and thus solidifies the ink softened by heating and suppresses a temperature change of the sheet caused by downstream devices. The cooling module 5000 includes a plurality of cooling units 5100. The plurality of cooling units 5100 cools the high-temperature sheet conveyed from the fixing module 4000. Each cooling unit 5100 is configured to cool a sheet by taking outside air into a cooling box with a fan to increase the pressure in the cooling box, and by exposing the sheet to air blown out from nozzles formed in a conveyance guide. The plurality of cooling units 5100 is arranged on both sides of the conveyance path, and hence can cool the sheet from both sides.

A conveyance path switching unit is provided in the cooling module 5000. The conveyance path switching unit switches conveyance paths for the sheet according to whether the sheet is conveyed to the reversing module 6000 or to a double-sided printing conveyance path to be used for double-sided printing.

During double-sided printing, the sheet is conveyed to the lower conveyance path in the cooling module 5000, and is conveyed through the double-sided printing conveyance paths of the fixing module 4000, the drying module 3000, the printing module 2000, and the sheet feeding module 1000. A double-sided printing conveyance unit of the fixing module 4000 is provided with a first reversing unit 4200 that reverses the front and back surfaces of the sheet. After the sheet is once conveyed to the first reversing unit 4200, the sheet is reversed and conveyed to the drying module 3000 side, and thus the printed surface with the image is reversed. Owing to conveyance of the sheet through the first reversing unit 4200, printing can be performed on the back surface of the sheet. The sheet is then conveyed again to the pre-image-forming registration correction unit, the print belt unit 2200, and the recording unit 2300 of the printing module 2000, and printing is performed on the sheet.

The reversing module 6000 includes a second reversing unit 6400. The reversing module 6000 can reverse, by the second reversing unit 6400, the front and back surfaces of the sheet to be conveyed. Thus, the orientation of the front and back surfaces of the sheet to be discharged can be changed. The sheet discharging and stacking module 7000 includes a top tray 7200 and a stacking unit 7500. The sheet discharging and stacking module 7000 aligns and stacks the sheets conveyed from the reversing module 6000 onto the top tray 7200 or the stacking unit 7500.

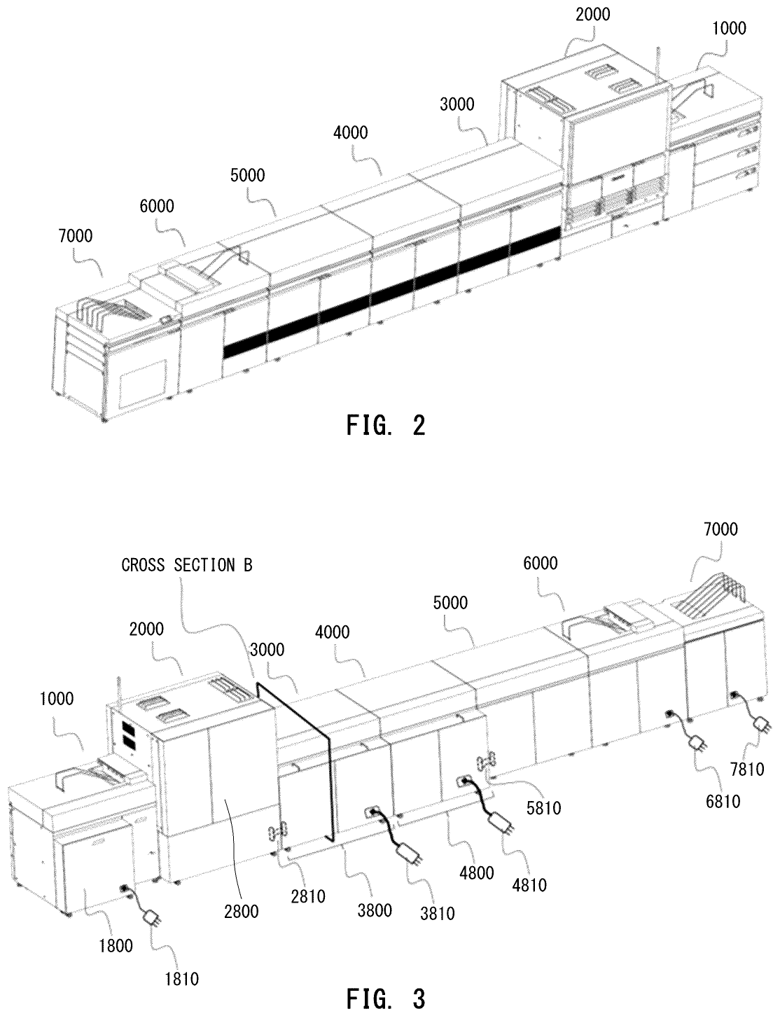

FIG. 2 is a perspective view for illustrating the ink-jet recording system 100 as viewed from the upper front side. FIG. 3 is a perspective view for illustrating the ink-jet recording system 100 as viewed from the upper rear side. External electric component modules 1800, 2800, 3800, and 4800 are mounted on outer sides on the rear side of casings of the sheet feeding module 1000, the printing module 2000, the drying module 3000, and the fixing module 4000, respectively. The external electric component module corresponding to each module is shipped in a separated state, and is combined and connected at an installation location. That is, the external electric component module corresponding to each module can be separated even after being combined and connected. Four casters may be mounted on a bottom surface of each of the external electric component modules 1800, 2800, 3800, and 4800. With the casters being mounted on each of the external electric component modules 1800, 2800, 3800, and 4800, even under a state in which each of the external electric component modules 1800, 2800, 3800, and 4800 is separated, the external electric component module can be easily moved. In the following, in some cases, description is given of an example of a pair of a specific module and a corresponding external electric component module. In this case, unless particularly noted, the same holds true also for other modules and corresponding external modules.

A frame of each of the external electric component modules 1800, 2800, 3800, and 4800 is fastened and fixed by screws to the casing of the corresponding one of the sheet feeding module 1000, the printing module 2000, the drying module 3000, and the fixing module 4000. The external electric component modules 1800, 2800, 3800, and 4800 mainly have power supply units and control units mounted thereon, which are incapable of being mounted inside of the casings of the sheet feeding module 1000, the printing module 2000, the drying module 3000, and the fixing module 4000. The external electric component modules 1800, 3800, and 4800 are supplied with alternating current (AC) power from a switchboard of an installation building by power supply cables 1810, 3810, and 4810, respectively. The power supply units and the control units are specific examples of an electric component unit provided in the external electric component module.

The reversing module 6000 and the sheet discharging and stacking module 7000 have power supply units mounted therein, and are not provided with the external electric component module. Thus, the reversing module 6000 and the sheet discharging and stacking module 7000 are supplied with AC power by directly connecting power supply cables 6810 and 7810 to the inside on the rear side.

AC power is supplied to each of the printing module 2000 and the cooling module 5000 from the external electric component module provided on the adjacent module. First, description is given of a power supply cable 2810 (broken line) for supplying AC power to the printing module 2000. An opening is formed in each of a side surface of the external electric component module 2800 of the printing module 2000 and a side surface of the external electric component module 3800 of the adjacent drying module 3000, which face each other. The power supply cable 2810 is arranged through those openings. The power supply cable 2810 is connected to the power supply unit of the external electric component module 3800, and supplies AC power to the printing module 2000 and the external electric component module 2800. AC power is similarly supplied to the cooling module 5000 through use of a power supply cable 5810 (broken line) from the external electric component module 4800 of the fixing module 4000. As described above, the power supply cables 2810 and 5810 are arranged inside of the external electric component modules, and do not pass between the drying module 3000 and the corresponding external electric component module 3800. The power supply cable may be connected to the adjacent module, and hence the power supply cable is arranged so as to pass through the openings of the module side surfaces in order to reduce the length of the power supply cable.

### Drying Module

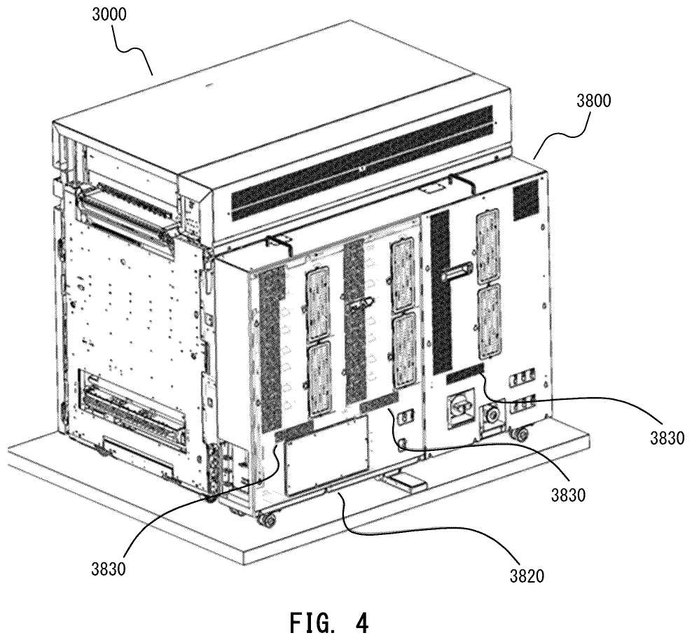

FIG. 4 is a detailed perspective view for illustrating the drying module 3000 and the external electric component module 3800 corresponding to the drying module 3000 as viewed from the upper rear side. The external electric component module 3800 includes a bottom plate 3820 and covers for respective surfaces arranged on the bottom plate 3820. On the cover on the rear side of the external electric component module 3800, a plurality of (in this case, three) louvers 3830 is provided. The louvers 3830 are inlets of air.

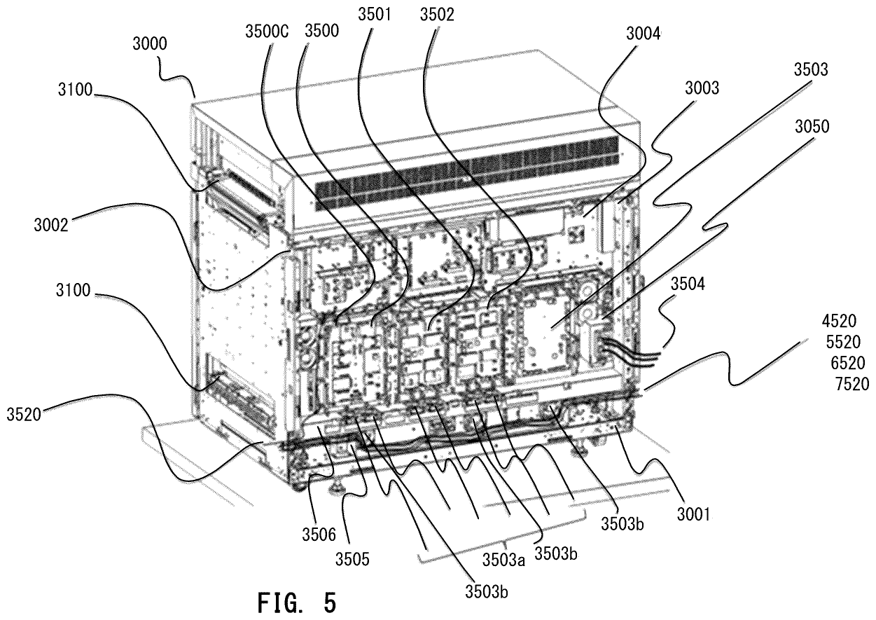

FIG. 5 is a perspective view for illustrating the drying module 3000 in a state without the external electric component module 3800 as viewed from the upper rear side. The drying module 3000 includes a bottom plate 3001, and a rear right column 3002 and a rear left column 3003 supported by the bottom plate 3001. The rear right column 3002 and the rear left column 3003 are each welded and fixed to a corner of the bottom plate 3001 on the rear side. At a position sandwiched between the rear right column 3002 and the rear left column 3003, a rear side plate 3004 is fixed perpendicularly to the bottom plate 3001. A plurality of electric component units is arranged on the rear side of the rear side plate 3004. That is, the electric component unit of the drying module 3000 is arranged on the external electric component module 3800 side (that is, the rear side) in the crossing direction crossing with the sheet conveying direction. An electrical wire bundle 3504 to be connected to the external electric component module 3800 is connected to a connector base 3050 provided on the right side as viewed from the rear side. With the electrical wire bundle 3504, AC power is supplied from the external electric component module 3800 to the drying module 3000.

The AC power supplied from the electrical wire bundle 3504 is converted into a predetermined voltage by a power supply board 3503, and is distributed to each electrical board. Main electrical boards are, from the left as viewed from the rear side, a main control board 3500, a first sub-control board 3501, and a second sub-control board 3502. The first sub-control board 3501 and the second sub-control board 3502 mainly perform motor drive control of conveyance units 3100 for conveying sheets and units for the drying function, which are provided on the front side of the drying module 3000, and detection control of sensors. The units for the drying function are the decoupling unit 3200, the drying belt unit 3300, and the warm air blowing unit 3400 described above. The main control board 3500 gives instructions of operation timings to each board. Each of the main control board 3500, the first sub-control board 3501, the second sub-control board 3502, the power supply board 3503, and the like described above is provided on the rear side of the drying module 3000. The main control board 3500, the first sub-control board 3501, the second sub-control board 3502, the power supply board 3503, and the like are an electric component unit on the main body side (main body-side electric component unit).

Each module other than the drying module 3000 is also provided with at least one main control board to control the operation of the corresponding module. Further, in the printing module 2000, an overall control unit to be described later is provided on any one of the main body of the printing module 2000 and the external electric component module 2800. The overall control unit controls the main control boards of the plurality of modules forming the ink-jet recording system 100 to totally control the ink-jet recording system 100.

### Electrical Connection of Electric Component Modules

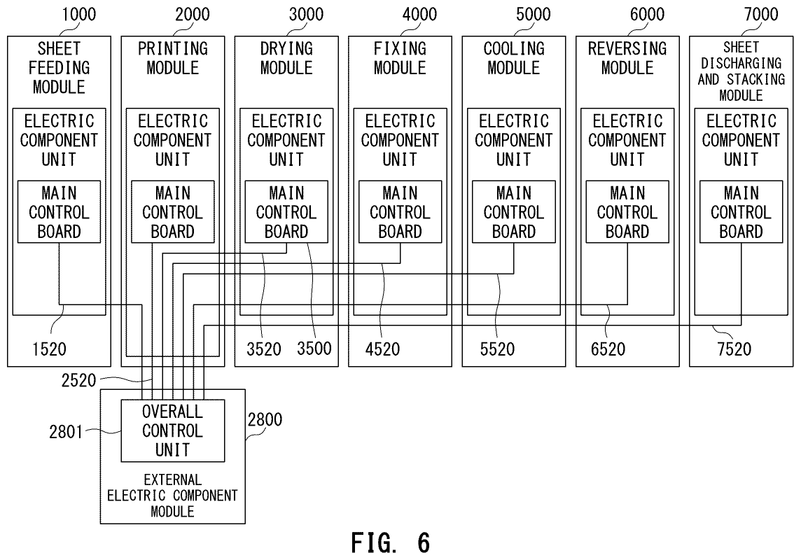

FIG. 6 is an explanatory diagram for illustrating a connection relationship of the electric component modules mounted on the respective modules. To an overall control unit 2801 of the printing module 2000, the connection cables from other modules are collectively connected. In this case, description is given of an example in which the overall control unit 2801 is arranged in the external electric component module 2800. The connection cables from the main control boards of the respective modules are collectively connected to a connection port of the overall control unit 2801.

In order to connect the overall control unit 2801 and each of the plurality of main control boards to each other, as illustrated in FIG. 5, a plurality of connection cables 3520, 4520, 5520, 6520, and 7520 is provided. Those connection cables are connection cables to be used for transmission of various signals such as a control signal, and for electrically connecting the modules to each other.

The main control board 3500 of the drying module 3000 is connected to the overall control unit of the printing module 2000 by the connection cable 3520. As illustrated in FIG. 5, in an upper portion of the main control board 3500, a connector port 3500C to which the connection cable 3520 is connected is arranged. The connection cable 3520 is guided downward by being supported by a wire saddle provided at a left edge as viewed from the rear side of the main control board 3500, supported by a wire saddle provided at a lower portion of the rear right column 3002, and is routed to the printing module 2000 side. The connection cable 3520 is mounted after the modules are coupled at the time of installation.

The main control boards of other modules are similarly connected to the overall control unit 2801 by any one of the plurality of connection cables 4520, 5520, 6520, and 7520. For example, one connection cable 4520 connects the main control board arranged in the fixing module 4000 and the overall control unit 2801 to each other. The sheet feeding module 1000 is arranged on a side opposite to the drying module 3000 with reference to the printing module 2000. Accordingly, a connection cable 1520 for connecting the sheet feeding module 1000 and the overall control unit 2801 to each other is not shown in FIG. 5.

In the example of FIG. 6, description has been given of a configuration in which the overall control unit 2801 and the main control board of each of the modules are connected to each other by an individual connection cable, but the electric component unit of each of the external electric component modules may be connected to the overall control unit 2801. For example, the electric component unit provided in the external electric component module 3800 of the drying module 3000 may be connected by the connection cable to the overall control unit 2801 provided in the external electric component module 2800 of the printing module 2000.

In this case, as illustrated in FIG. 3, the drying module 3000 is arranged between the printing module 2000 and the fixing module 4000. Accordingly, the connection cable 4520 for connecting the overall control unit 2801 and the main control board arranged in the fixing module 4000 to each other is arranged so as to pass through the drying module 3000. A part of the connection cable 4520 passing through the drying module 3000 is arranged between the drying module 3000 and the external electric component module 3800 coupled on the rear side of the drying module 3000. The connection cable 4520 is arranged below a lower end of the main control board of the drying module 3000 in the vertical direction crossing with both of the conveying direction and the crossing direction. The connection cable for connecting the overall control unit 2801 and the electric component unit provided in the external electric component module 4800 of the fixing module 4000 is similarly arranged so as to pass through the drying module 3000. This connection cable is also wired so as to pass below the lower end of the main control board of the drying module 3000, between the drying module 3000 and the external electric component module 3800 coupled on the rear side of the drying module 3000.

As described above, a space for the connection cable can be provided between the module main body and the external electric component module. As a result, as illustrated in FIG. 5, a plurality of connection cables can be appropriately arranged. For appropriate arrangement of cables, although there are various viewpoints, for example, the arrangement avoids, for example, forced bending and extreme slack for bypassing a structure. The same holds true also for the connection cables 5520, 6520, and 7520 connected to other main control boards. For example, the connection cable 5520 connected to the cooling module 5000 is arranged so as to pass through the drying module 3000 and the fixing module 4000. A part passing through the fixing module 4000 is arranged below the lower end of the main control board of the fixing module 4000, between the fixing module 4000 and the external electric component module 4800 coupled on the rear side of the fixing module 4000.

In a case where the seven modules are coupled as in this embodiment, the entire length of the ink-jet recording system 100 in the longitudinal direction is close to 9 m, but the connection cable directly connects the main control board and the overall control unit to each other without a relay. In a case where a relay is interposed, a change may be caused in the waveform of the signal transmitted through the connection cable, and a delay may be caused in signal passing. As the connection cable, for example, a 1-Gbps (gigabits per second) class local area network (LAN) cable is suitable. In some cases, the LAN cable of this class is thick. Accordingly, in a case where a LAN cable for a communication speed of 1 Gbps or more is to be used, the effect of this embodiment can be remarkedly obtained.

The connection cables 4520, 5520, 6520, and 7520 passing through the drying module 3000 are held by a cable guide provided on a lower portion of the rear left column 3003 and a cable guide provided on a lower portion of the rear right column 3002. In a region between the rear left column 3003 and the rear right column 3002, the connection cable is restricted and held by a plurality of cable guides on a guide support plate fixed on the bottom plate 3001.

A plurality of fans 3503a is arranged below the main control board 3500, the first sub-control board 3501, and the second sub-control board 3502. Those fans 3503a blow air to mounting surfaces of electrical components of the main control board 3500, the first sub-control board 3501, and the second sub-control board 3502 to cool the electrical components on the mounting surfaces. The fans 3503a are fixed to a duct 3506 for cooling, which is arranged below the main control board 3500, the first sub-control board 3501, and the second sub-control board 3502 in the vertical direction. The duct 3506 is fixed to the rear side plate 3004 so as to occupy the entire width between the rear left column 3003 and the rear right column 3002.

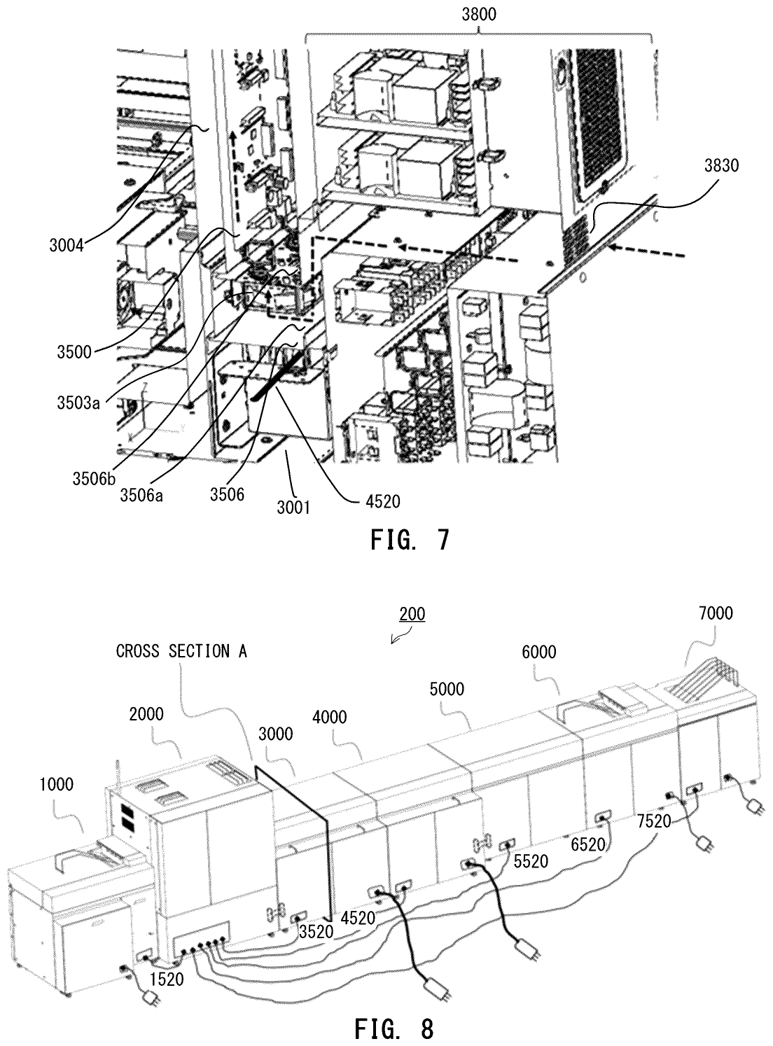

FIG. 7 is an enlarged view of cross sections of the duct 3506 and a peripheral part thereof as viewed from diagonally above. In the external electric component module 3800, a louver 3830 is provided as an intake of air. Air taken in from the louver 3830 passes through the inside of the external electric component module 3800 to flow into an entrance opening 3506a of the duct 3506. The axial fan 3503a forcibly discharges the air from an exit opening 3506b provided above an area of a lower portion of the duct 3506 to blow the air to the main control board 3500, the first sub-control board 3501, and the second sub-control board 3502. An airflow path is formed as described above. The broken-line arrow of FIG. 7 indicates the airflow path. The connection cables 4520, 5520, 6520, and 7520 are wired below a lower surface of the duct 3506. Accordingly, the connection cables 4520, 5520, 6520, and 7520 do not affect the airflow caused by the axial fan 3503a, and thus the cooling effect is not lost.

### Modification Example

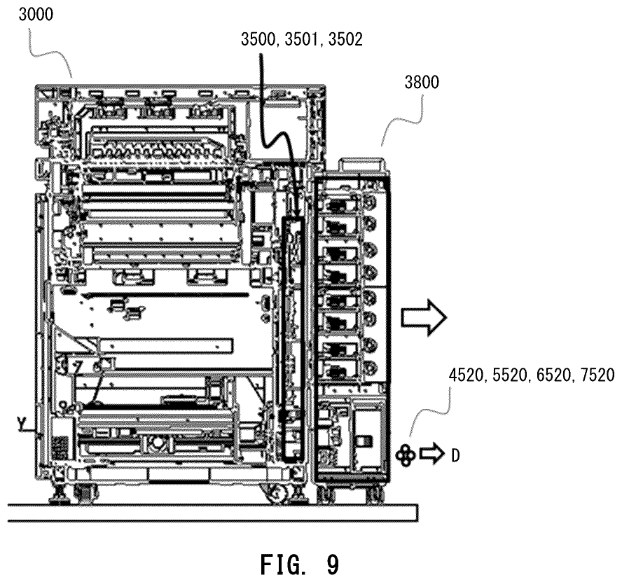

Description is now given of a connection configuration of an ink-jet recording system 200 in another mode. FIG. 8 is an explanatory view for illustrating the connection configuration of the ink-jet recording system 200 in another mode. Parts similar to those of the ink-jet recording system 100 are denoted by the same reference symbols. The connection cables 1520, 3520, 4520, 5520, 6520, and 7520 from the respective modules are wired outside of the ink-jet recording system 200 to be collectively connected to the printing module 2000. FIG. 9 is a cross-sectional view of a position of a cross section A of the drying module 3000 as viewed from the printing module 2000 side.

In order to get access to the main control board 3500, the first sub-control board 3501, and the second sub-control board 3502, the external electric component module 3800 may be separated from the drying module 3000. At this time, as illustrated in FIG. 9, the connection cables 4520, 5520, 6520, and 7520 may be moved in the arrow D direction. When the electrical wire bundle 3504 electrically connecting the external electric component module 3800 to the drying module 3000 is removed and the screws used for physical connection are removed, the external electric component module 3800 can be separated from the drying module 3000. In this manner, access is allowed to the electric component unit (such as the main control board 3500, the first sub-control board 3501, and the second sub-control board 3502) inside of the drying module 3000.

The connection cables 4520, 5520, 6520, and 7520 may be moved before the external electric component module 3800 is moved. The connection cables 4520, 5520, 6520, and 7520 are each connected to the rear side of each module from the rear side of the printing module 2000 with one cable without using a relay. In order to move the connection cables 4520, 5520, 6520, and 7520, any one connection portion of each of the connection cables 4520, 5520, 6520, and 7520 may be separated. However, the removing and mounting work of the connection portion of each of the connection cables 4520, 5520, 6520, and 7520 is very troublesome.

There is also a method of providing the connection cables 4520, 5520, 6520, and 7520 with excess lengths so that the external electric component module 3800 is moved to escape by the amount of the excess lengths. However, in this method, places may be secured to place the excess lengths of the connection cables 4520, 5520, 6520, and 7520. As described above, in the ink-jet recording system 200, the work of separating the external electric component module 3800 is difficult.

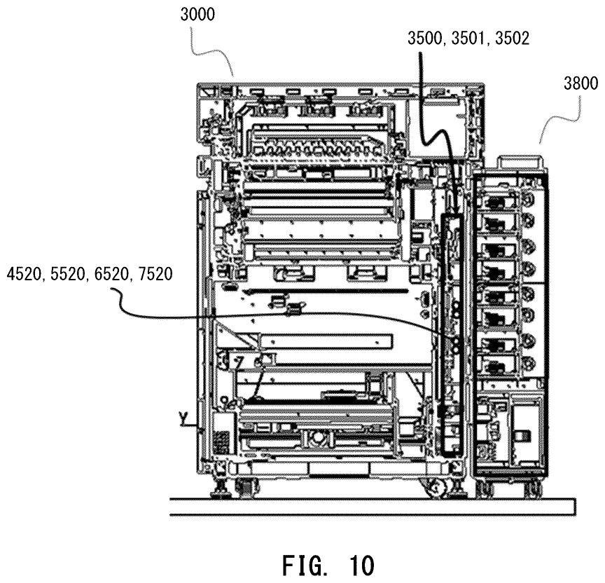

In view of the above, in the ink-jet recording system 200, the connection cables 4520, 5520, 6520, and 7520 are wired inside of the casing of each module. FIG. 10 is an explanatory view for illustrating a configuration in which the connection cables 4520, 5520, 6520, and 7520 are wired inside of the casing of the drying module 3000.

The connection cables 4520, 5520, 6520, and 7520 are arranged in a region on the rear side of the main control board 3500, the first sub-control board 3501, and the second sub-control board 3502, between those boards and the external electric component module 3800. The region between the external electric component module 3800 and the main control board 3500, the first sub-control board 3501, and the second sub-control board 3502 forms an airflow path for cooling the heat generated from mounted components on the mounting surfaces of the boards. Accordingly, the presence of the connection cables 4520, 5520, 6520, and 7520 in this region affects the efficient cooling of the electrical boards.

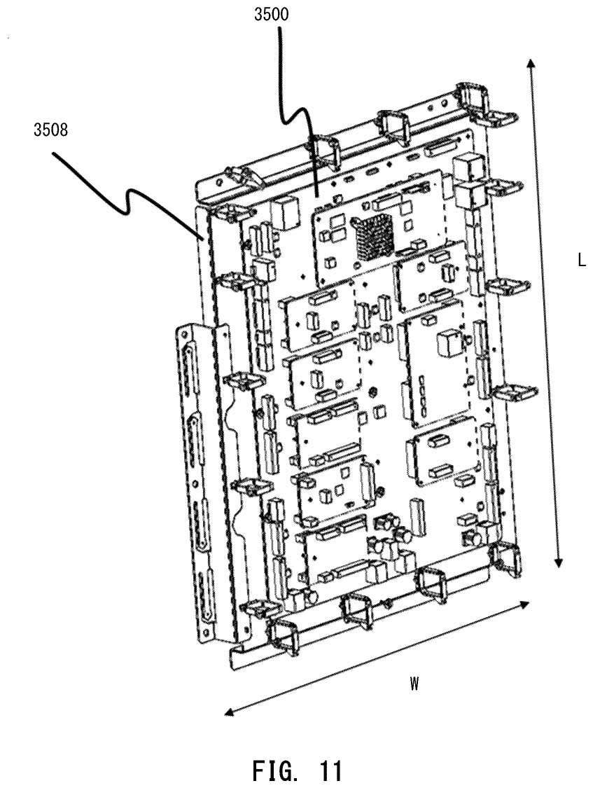

In a case where any one of the main control board 3500, the first sub-control board 3501, and the second sub-control board 3502 is failed, the failed component is replaced. For example, in a case where the main control board 3500 is failed, the main control board 3500 and a fixing member therefor are integrally replaced. FIG. 11 is a configuration view for illustrating the main control board 3500 and a board support 3508 that is the fixing member for the main control board 3500.

The board support 3508 has a vertical dimension L and a lateral dimension W. At the time of replacement of the main control board 3500, it is preferred that an obstacle be absent in the rear direction of the drying module 3000 in a range of the vertical dimension L and the lateral dimension W. In a case where the connection cables 4520, 5520, 6520, and 7520 are arranged in this region, the work of removing the connection cables 4520, 5520, 6520, and 7520 and the work of mounting the connection cables 4520, 5520, 6520, and 7520 are added to the work of replacing the main control board 3500. Accordingly, the maintenance time is greatly increased, and the maintenance efficiency is reduced.

### Relative Comparison of Two Systems

The ink-jet recording system 100 and the ink-jet recording system 200 are both similar in the technical advantage in that the cables can be appropriately arranged. Meanwhile, regarding the difficulty in movement of the connection cables 4520, 5520, 6520, and 7520, efficient cooling of the electrical board, and efficiency in component replacement, it can be said that the ink-jet recording system 100 is superior to the ink-jet recording system 200. Description is given of additional elements that contribute to the superiority of the ink-jet recording system 100.

As illustrated in FIG. 5, the connection cables 4520, 5520, 6520, and 7520 are wired below a projection region to the rear side of the electric component unit of the drying module 3000 (main body-side electric component unit). Accordingly, the main body-side electric component unit inside of the casing of the drying module 3000 can be easily replaced by moving the external electric component module 3800 on the exterior rear side of the drying module 3000, without moving the connection cables 4520, 5520, 6520, and 7520. The maintenance efficiency is improved as described above.

Moreover, the path for the connection cables 4520, 5520, 6520, and 7520 is secured below the duct 3506 inside of the casing of the drying module 3000, and thus a sufficient space is secured for the airflow path for cooling the main body-side electric component unit. The connection cables 4520, 5520, 6520, and 7520 do not affect the efficient cooling of the main body-side electric component unit obtained by the airflow.

The ink-jet recording system 100 has a function of conveying the sheet having an image printed thereon in all of the modules. For example, in the case of the drying module 3000, the drying module 3000 includes the decoupling unit 3200, the drying belt unit 3300, and the warm air blowing unit 3400 in an upper portion, and includes a return path conveyance unit 3450 to be used at the time of double-sided printing in a lower portion.

FIG. 12 is a cross-sectional view obtained by viewing the drying module 3000 from the printing module 2000 side at a cross section B of FIG. 3. The decoupling unit 3200, the drying belt unit 3300, and the warm air blowing unit 3400 are provided in an upper region of the drying module 3000. The return path conveyance unit 3450 used at the time of double-sided printing is provided in a lower region. The electric component unit (main control board 3500, first sub-control board 3501, and second sub-control board 3502) is arranged on the rear side of the rear side plate 3004. A motor 3310 of the drying belt unit 3300 and a motor 3451 of the return path conveyance unit 3450 are arranged on the front side of the rear side plate 3004.

The heat generation by the motor 3451 of the return path conveyance unit 3450 may be controlled so that the temperature inside of the drying module 3000 is prevented from rising. The heat generated by the motor 3451 is dissipated by providing an airflow path in the rear direction from the front side of the drying module 3000. Thus, as illustrated in FIG. 5, an axial fan 3503b is provided in a lower part of the rear side plate 3004 close to the duct 3506 provided below the main body-side electric component unit of the drying module 3000. Air discharged by the axial fan 3503b passes through a gap 3900 between the drying module 3000 and the external electric component module 3800 so as to be discharged from the lower side of the bottom plate 3820 of the external electric component module 3800.

A cooling airflow path for the main body-side electric component unit of the drying module 3000 and a cooling airflow path for the motor 3451 of the return path conveyance unit 3450 are isolated from each other by the duct 3506. Accordingly, the dissipation of heat is efficiently performed in each place, and efficient cooling is allowed.

A wiring path for the connection cables 4520, 5520, 6520, and 7520 is isolated from the airflow path for the main body-side electric component unit of the drying module 3000 by the duct 3506. The cooling airflow path for the motor 3451 of the return path conveyance unit 3450 and the wiring path for the connection cables 4520, 5520, 6520, and 7520 share a part of the space. Thus, a new space may not be needed to be secured, and an increase in size of the apparatus can be suppressed. In a case where the connection cables 4520, 5520, 6520, and 7520 are wired near an exhaust port of the axial fan 3503b, efficient air exhausting cannot be performed. In order to achieve efficient air exhausting, it is preferred that the connection cables 4520, 5520, 6520, and 7520 be wired so as to be separated to the rear side as much as possible from the rear side plate 3004.

In the description above, description has been given of the configuration of the drying module 3000 provided with the external electric component module 3800, but, also in other modules, in a case where the external electric component module (external unit) is provided, the above-mentioned configuration can be applied. That is, the above-mentioned configuration is effective in a configuration in which, in an image forming system formed by coupling a plurality of modules, connection cables are collectively connected to a predetermined module from other modules or external units and an external module is provided on any one of the modules. In a case where a module to which the connection cables are collectively connected is the most upstream, in a module arranged on the upstream side having a short physical distance to the module, a connection cable from a module coupled on the downstream side or from an external unit thereof is wired inside of the casing. In a case where the above-mentioned configuration is adopted in such a case, the connection cable from the downstream module or the external unit does not affect the dissipation of heat of the module arranged on the upstream side. Further, even when the external unit is provided to the rear side of the module arranged on the upstream side, the access to the electric component module in the module does not affect the connection cable from the downstream module. Accordingly, the maintenance performance in the module is increased, and the dissipation of heat from the inside of the module is efficiently performed. Such a configuration is effective even when, to one external unit, other modules and other external units are collectively connected.

In this embodiment, the ink-jet recording system 100 has been described as the image forming system, but the image forming system may be configured to form an image by a system other than the ink-jet system, such as an electrophotographic system. In any case, the configuration of this embodiment is effective as long as the image forming system has a configuration which is formed of a plurality of modules and in which a connection cable is connected to one predetermined module from each of other modules.

### Second Embodiment

The overall configuration of the ink-jet recording system 100 of a second embodiment of the present disclosure is similar to that in the first embodiment illustrated in FIG. 1 to FIG. 3, and hence description thereof is omitted.

### Drying Module

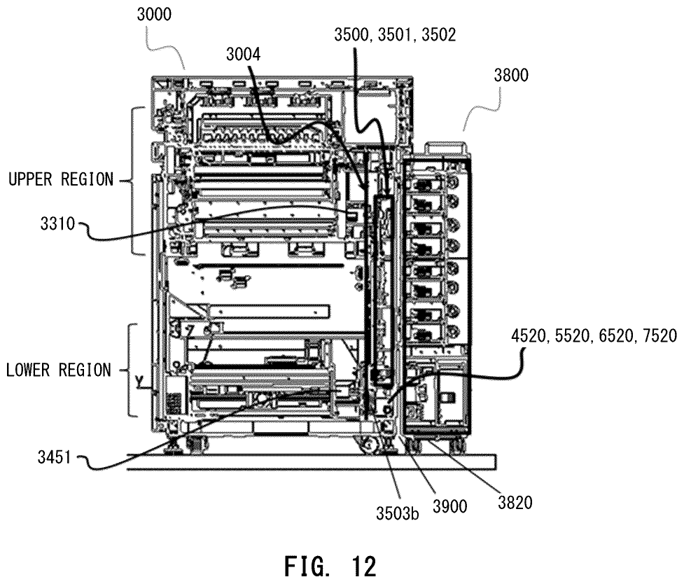

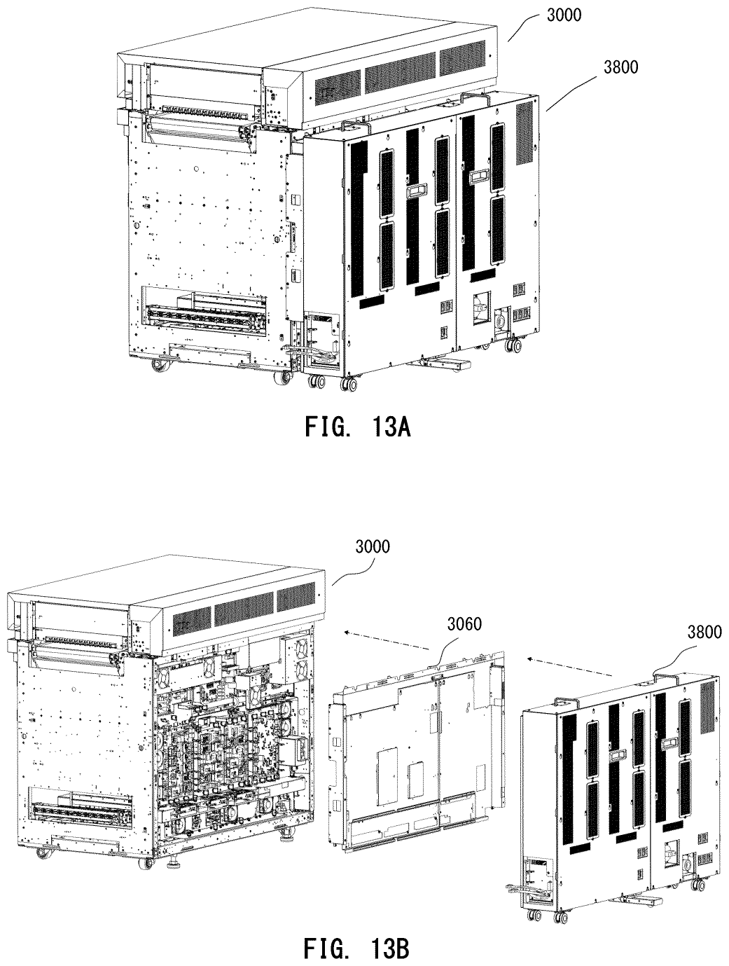

FIGS. 13A and 13B are detailed configuration views for illustrating the drying module 3000 and the external electric component module 3800 corresponding to the drying module 3000. FIG. 13A is a perspective view, and FIG. 13B shows a disassembled state. The external electric component module 3800 is arranged on the rear side of the drying module 3000. An electric component inner cover 3060 is provided at a connection surface between the modules. The electric component inner cover 3060 protects an electric component unit to be described later provided on the rear side of the drying module 3000.

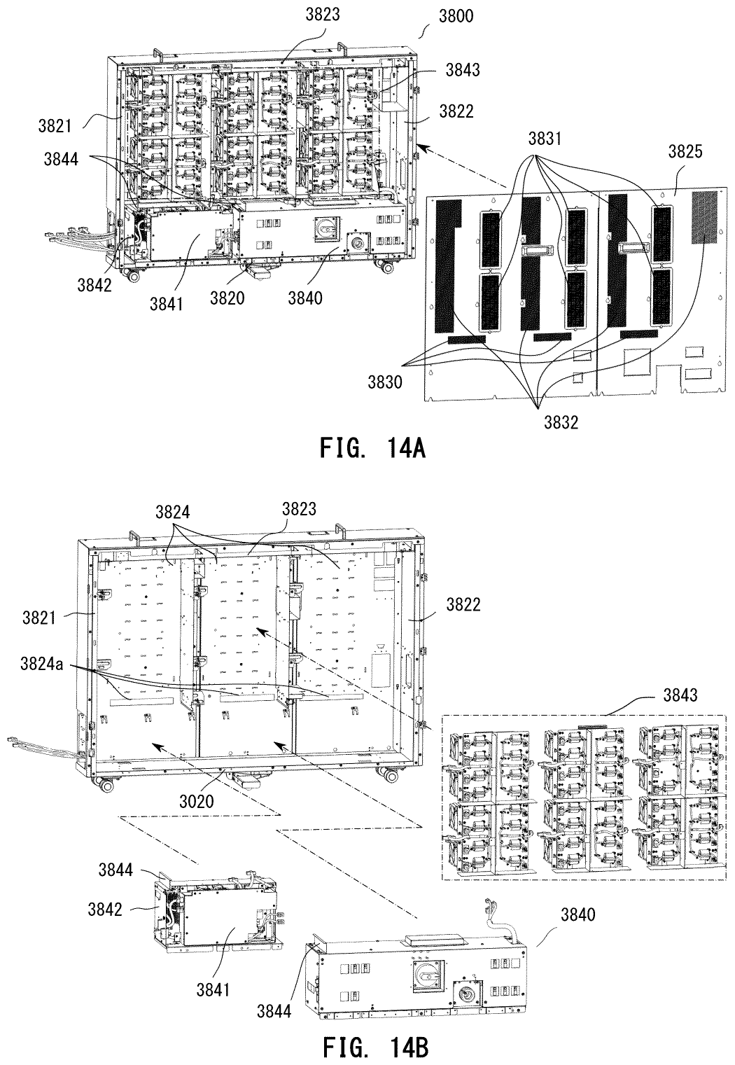

FIGS. 14A and 14B are configuration views for illustrating the external electric component module 3800. FIG. 14A is a perspective view of the external electric component module 3800 as viewed from the upper rear side, and FIG. 14B is an exploded perspective view.

The external electric component module 3800 includes a frame structure including an annex bottom plate 3820 at a bottom surface portion, an annex right column 3821, an annex left column 3822, a top surface stay 3823, and an annex front side plate 3824. The annex right column 3821 is arranged on the right side of the bottom plate 3820. The annex left column 3822 is arranged on the left side of the bottom plate 3820. The top surface stay 3823 is opposed to the bottom plate 3820, and connects the annex right column 3821 and the annex left column 3822 to each other. The annex front side plate 3824 is arranged on the apparatus front side of the bottom plate 3820, the top surface stay 3823, the annex right column 3821, and the annex left column 3822.

The external electric component module 3800 includes therein a power cord base and circuit breaker unit 3840 for branching the AC power supplied from the outside to the printing module 2000 and the drying module 3000. In the power cord base and circuit breaker unit 3840, a circuit breaker is arranged for each system of electrical loads. Further, the external electric component module 3800 includes a power supply filter unit 3841, a relay and terminal unit 3842, and a direct current (DC) power supply unit 3843. The power supply filter unit 3841 prevents inflow and outflow of power supply noise from the outside and to the outside. The relay and terminal unit 3842 branches and distributes power to each supply destination. The DC power supply unit 3843 converts the AC voltage into a DC voltage of 24 volts (V) or 38 V.

For the purpose of protecting those units, an annex rear cover 3825 is provided on the rear side of the external electric component module 3800. At the time of service maintenance or the like, the annex rear cover 3825 is removed so that access is allowed to each unit inside of the external electric component module 3800. A particularly high voltage is applied inside of the power cord base and circuit breaker unit 3840, the power supply filter unit 3841, and the relay and terminal unit 3842. Thus, for the purpose of protecting the user and the service worker, each of those units has a configuration including a cover for each unit.

In the annex rear cover 3825, a plurality of ventilation louvers is provided. The plurality of ventilation louvers is shared by both of the external electric component module and the drying module on the front side. The louvers for the external electric component module are annex intake louvers 3831 and annex exhaust louvers 3832 for the airflow for cooling the DC power supply unit 3843 inside of the external electric component module. Because of the relationship in that the rear side of the drying module 3000 is covered with the external electric component module, the louvers for the drying module pass through the external electric component module 3800 to take in and exhaust external air. The louvers 3830 for the airflow for cooling the rear electric component portion of the drying module 3000 to be described later are also included in the louvers for the drying module. The annex exhaust louvers 3832 also serve as exhaust louvers for the entire drying module 3000.

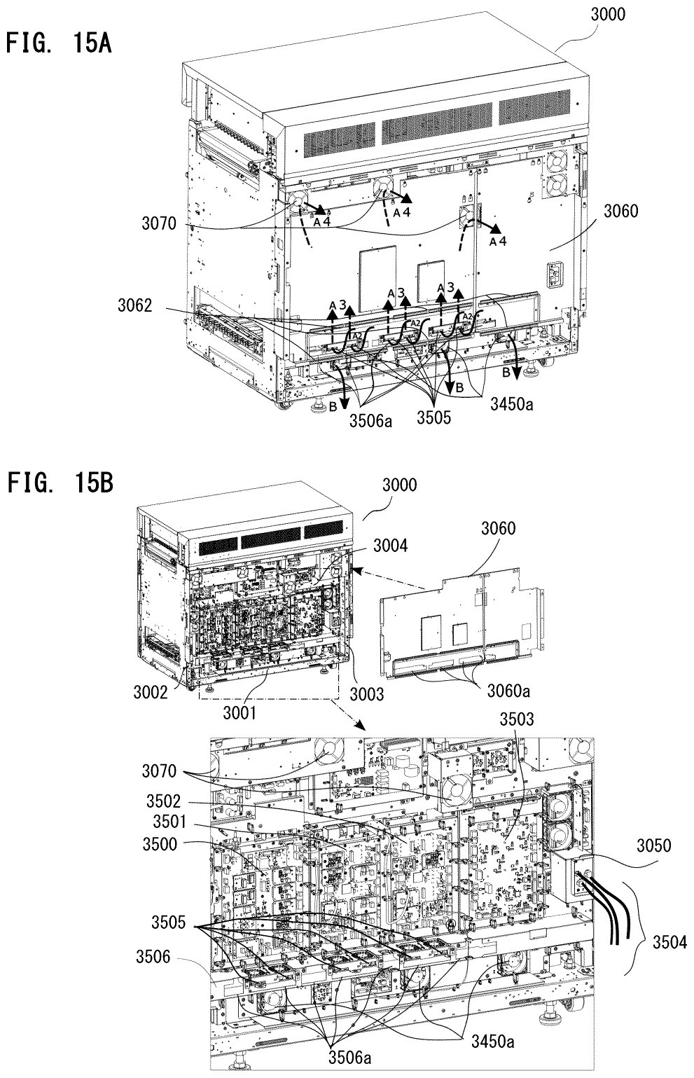

FIGS. 15A and 15B are configuration views for illustrating the drying module 3000 from which the external electric component module 3800 is disconnected. FIG. 15A is a perspective view for illustrating the drying module 3000 from the upper rear side, and FIG. 15B is an exploded perspective view for illustrating the drying module 3000 from the upper rear side, and a partial enlarged view thereof. The drying module 3000 includes the bottom plate 3001, and the rear right column 3002 and the rear left column 3003 supported by the bottom plate 3001. The rear right column 3002 and the rear left column 3003 are each welded and fixed to the corner of the bottom plate 3001 on the rear side. The rear side plate 3004 is fixed perpendicular to the bottom plate 3001 at a position sandwiched between the rear right column 3002 and the rear left column 3003. A plurality of electric component units is arranged on the rear side of the rear side plate 3004. That is, the electric component unit of the drying module 3000 is arranged on the external electric component module 3800 side (that is, the rear side) in the crossing direction of crossing with the sheet conveying direction. The electrical wire bundle 3504 connected to the external electric component module 3800 is connected to the connector base 3050 present on the right side as viewed from the rear side. The electrical wire bundle 3504 supplies AC power to the drying module 3000 from the external electric component module 3800.

The AC power supplied from the electrical wire bundle 3504 is converted to DC by the DC power supply unit (not shown) provided inside of the drying module, and is then converted into a predetermined voltage by the power supply board 3503 so as to be distributed to each electrical board. Main electrical boards are, from the left as viewed from the rear side, the main control board 3500, the first sub-control board 3501, and the second sub-control board 3502. The first sub-control board 3501 and the second sub-control board 3502 mainly perform motor drive control of the conveyance units 3100 (see FIG. 5) for conveying sheets and units for the drying function, which are provided on the front side of the drying module 3000, and detection control of sensors. The units for the drying function are the decoupling unit 3200, the drying belt unit 3300, and the warm air blowing unit 3400 described above (see FIG. 1 for each unit).

As described with reference to FIG. 6, each of the modules other than the drying module 3000 is also provided with at least one main control board, and the main control board controls the operation of the corresponding module. Moreover, in the printing module 2000, the overall control unit 2801 is provided in any one of the main body of the printing module 2000 and the external electric component module 2800. The overall control unit 2801 controls the main control boards of the plurality of modules forming the ink-jet recording system 100 to totally control the ink-jet recording system 100.

As described above, the main control board 3500, the first sub-control board 3501, and the second sub-control board 3502 are connected to electrical loads provided in the respective units of the drying module 3000, and are supplied with currents corresponding to operations thereof. Thus, a driver element mounted on the board generates heat. Thus, a plurality of board cooling fans 3505 is arranged below the main control board 3500, the first sub-control board 3501, and the second sub-control board 3502 in the vertical direction. The plurality of board cooling fans 3505 blows air to cool the driver elements mounted on the respective boards (air path A3). The board cooling fans 3505 are fixed to the duct 3506 provided for separation and shielding, which is arranged below the main control board 3500, the first sub-control board 3501, and the second sub-control board 3502 in the vertical direction.

The duct 3506 has two main roles. One role is a role of shielding a space above the duct 3506 in which the main control board 3500, the first sub-control board 3501, and the second sub-control board 3502 are arranged from a space below the duct 3506. Immediately below the duct 3506, return path conveyance unit exhaust fans 3450a for ventilating the space inside of the apparatus in which the return path conveyance unit 3450 of the drying module 3000 is arranged are provided (air path B). The air exhausted by the return path conveyance unit exhaust fans 3450a may contain moisture and foreign matters (floating matters) such as paper powder taken into the apparatus together with the conveyed sheet. The duct 3506 blocks those moisture and foreign matters so as to prevent the moisture and foreign matters from being directly directed to a control board group provided above. Thus, the duct 3506 is fixed to the rear side plate 3004 so as to occupy substantially the entire width between the rear left column 3003 and the rear right column 3002.

At the time of mounting the electric component inner cover 3060, a lower portion of the electric component inner cover 3060 is fixed to the duct 3506. In this manner, the electric component inner cover 3060 forms a closed space together with the duct 3506 and the rear side plate 3004, and shields and protects the main control board 3500, the first sub-control board 3501, and the second sub-control board 3502 arranged inside of the space from the outside.

Another role of the duct 3506 is a role of a duct forming an air path. The duct 3506 separates intake paths of the plurality of board cooling fans 3505 from a space in the lower portion which has a possibility of being contaminated by the foreign matters, and takes in external air from an air path communicated with the outside via the external electric component module 3800 on the apparatus rear side. The entrance opening 3506a is provided as a plurality of openings on the apparatus rear side of the duct 3506. The entrance opening 3506a is a duct opening for communicating with an inner cover opening 3060a provided in the electric component inner cover 3060 and the air path passing through the external electric component module 3800 to form an air intake path for the board cooling fan 3505.

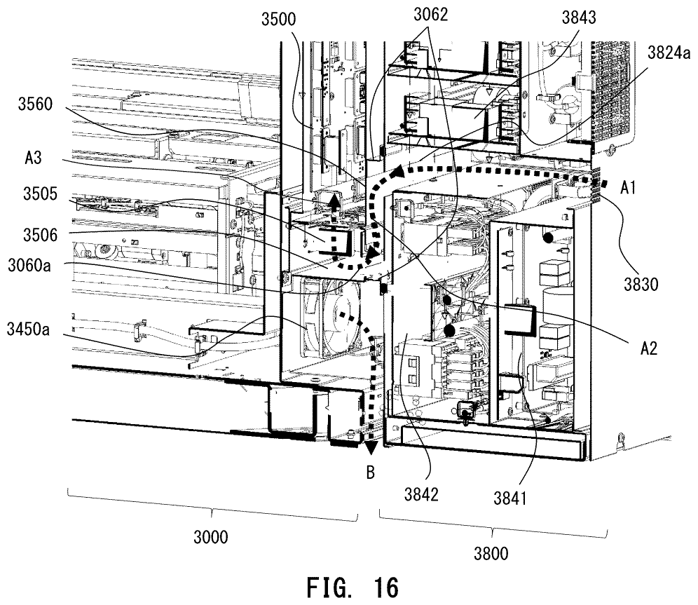

FIG. 16 is an enlarged cross-sectional view for illustrating an air path provided so as to pass through the external electric component module 3800. The air path A1 is formed at a position different in the vertical direction from the entrance opening 3506a (see FIGS. 15A and 15B) and the inner cover opening 3060a provided on the drying module 3000 side. This is because, as described above, a unit provided in the external electric component module 3800, in particular, a unit in the lower portion individually includes a protection cover, and an opening for forming an air wind path cannot be formed in the unit.

Thus, the air path A1 passing through the external electric component module 3800 may be formed between the units in the external electric component module 3800. For example, the air path A1 is formed between the DC power supply unit 3843 and each of the power cord base and circuit breaker unit 3840, the power supply filter unit 3841, and the relay and terminal unit 3842. The air path A1 is not provided as a duct for forming a wind path, but is formed as a space surrounded by the casing of each of the units described above and a vertical shielding member 3844 (see FIGS. 14A and 14B) partially provided in the apparatus width direction.

Relative to the positional difference in the vertical direction at a connection portion between the drying module 3000 and the external electric component module 3800, a space sandwiched between the electric component inner cover 3060 and the annex front side plate 3824 is a connection portion air path A2. The connection portion air path A2 passes through an annex intake port 3824a and the entrance opening 3506a, and has an upper side and a lower side sealed with lateral shielding members 3062 provided on the electric component inner cover 3060.

The connection portion air path A2 has a small thickness in the apparatus front-rear direction, but secures a sufficient flow path area of air by taking a sufficient width in the apparatus width direction. The duct 3506 is formed long in the apparatus width direction, and hence a plurality of entrance openings 3506a can be provided on the rear portion side. The entrance openings 3506a can be communicated with the connection portion air path A2 that is similarly widely secured in the apparatus width direction. With the connection portion air path A2, cooling air (air path A3) for the rear-side electric component portion of the drying module 3000 is formed. The connection portion air path A2 can pass through the external electric component module 3800 to take in the external air.

As described above, the board cooling fan 3505 discharges the air that has passed through the external electric component module 3800 (air path A1) and taken in via the connection portion air path A2 and the duct 3506 from the exit opening 3506b (see FIG. 7) provided in the upper surface of the duct 3506. In this manner, the board cooling fan 3505 can blow air to cool the main control board 3500, the first sub-control board 3501, and the second sub-control board 3502 (air path A3).

The air blown to the electric component board group flows through the space shielded by the electric component inner cover 3060 in the vertical direction to the apparatus upper portion, and is exhausted to the apparatus rear side by an electric component exhaust fan 3070 (air path A4: see FIGS. 15A and 15B).

At a position of the external electric component module 3800 opposed to the electric component exhaust fan 3070, similarly to the intake path, an exhaust path passing through the external electric component module 3800 is provided. The air exhausted through the air path A4 passes through the exhaust path, and is further discharged to the outside through the annex exhaust louver 3832 (see FIG. 14A) provided in the annex rear cover 3825 described above.

### Fixing Module

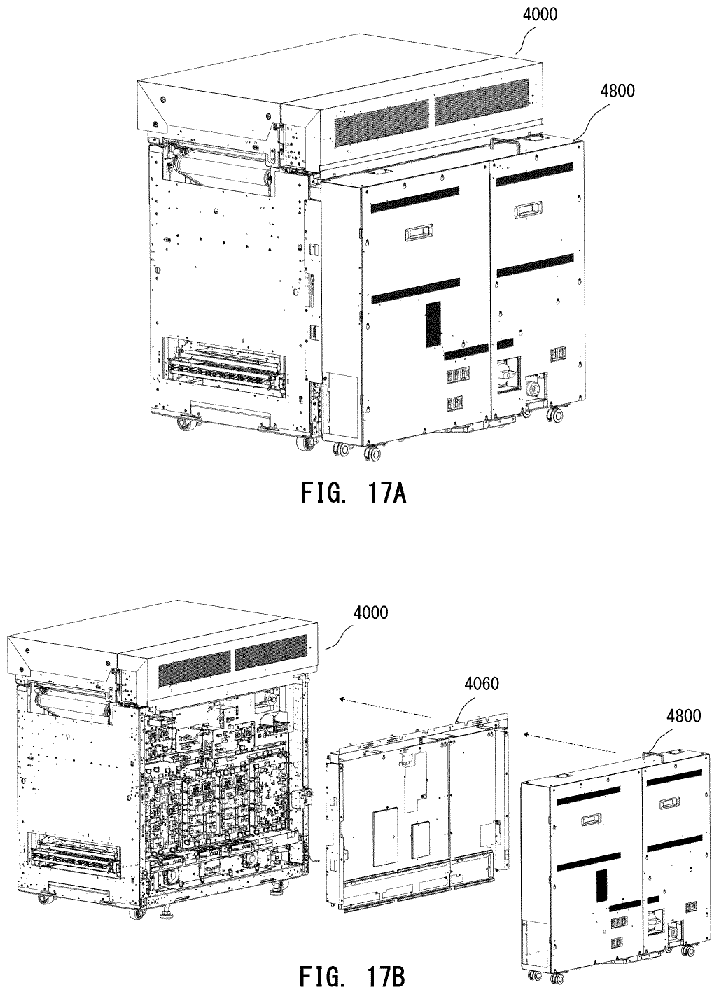

FIGS. 17A and 17B are detailed configuration views for illustrating the fixing module 4000 and the external electric component module 4800 corresponding to the fixing module 4000. FIG. 17A is a perspective view, and FIG. 17B shows a disassembled state. The external electric component module 4800 is arranged on the rear side of the fixing module 4000. An electric component inner cover 4060 is provided at a connection surface between the modules. The positional relationship between the fixing module 4000 and the external electric component module 4800 is similar to the positional relationship between the drying module 3000 and the external electric component module 3800 described above. The provision of the electric component inner cover 4060 on the fixing module 4000 side between the fixing module 4000 and the external electric component module 4800 is also similar.

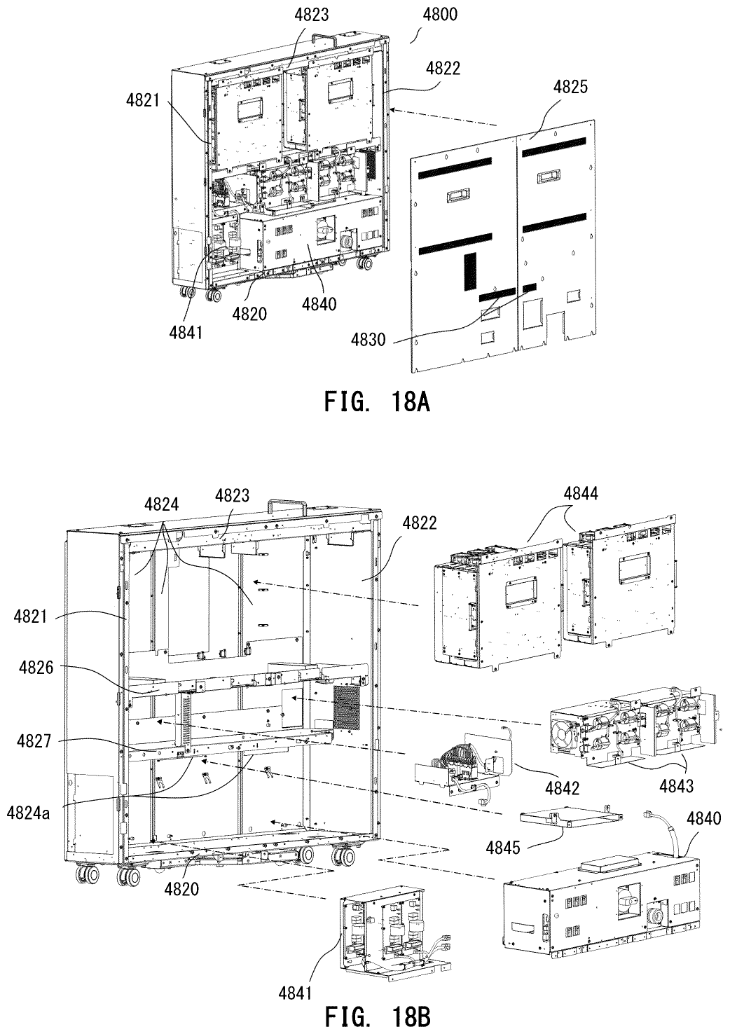

FIGS. 18A and 18B are configuration views for illustrating the external electric component module 4800. FIG. 18A is a perspective view of the external electric component module 4800 as viewed from the upper rear side, and FIG. 18B is an exploded perspective view.

The external electric component module 4800 includes a frame structure including an annex bottom plate 4820 at a bottom surface portion, an annex right column 4821, an annex left column 4822, a top surface stay 4823, and an annex front side plate 4824. The annex right column 4821 is arranged on the right side of the annex bottom plate 4820. The annex left column 4822 is arranged on the left side of the annex bottom plate 4820. The top surface stay 4823 is opposed to the annex bottom plate 4820, and connects the annex right column 4821 and the annex left column 4822 to each other. The annex front side plate 4824 is arranged on the apparatus front side of the annex bottom plate 4820, the top surface stay 4823, the annex right column 4821, and the annex left column 4822.

Inside of the external electric component module 4800, similarly to the external electric component module 3800, a power cord base and circuit breaker unit 4840 and a power supply filter unit 4841 are arranged. Above those units, two upper and lower stays (upper-stage stay 4826 and middle-stage stay 4827) are arranged. On the middle-stage stay 4827, a relay and terminal unit 4842 and a DC power supply unit 4843 are arranged. In an upper stage above the middle-stage stay, a heater driver board unit 4844 for adjusting the temperature of the fixing heater provided inside of the fixing belt unit 4100 of the fixing module 4000 is arranged.

For the purpose of protecting those units, an annex rear cover 4825 is provided on the rear side of the external electric component module 4800. At the time of service maintenance or the like, the annex rear cover 4825 is removed so that access is allowed to each unit inside of the external electric component module 4800. A particularly high voltage is applied inside of the power cord base and circuit breaker unit 4840, the power supply filter unit 4841, and the relay and terminal unit 4842. Thus, for the purpose of protecting the user and the service worker, each of those units has a configuration including a cover for each unit.

In the annex rear cover 4825, a plurality of ventilation louvers is provided. The plurality of ventilation louvers is shared by both of the external electric component module and the fixing module on the front side. The louvers for the external electric component module are intake louvers 4830 for the airflow for cooling the DC power supply unit 4843 inside of the external electric component module. Because of the relationship in that the rear side of the fixing module 4000 is covered with the external electric component module 4800, the louvers for the fixing module pass through the external electric component module 4800 to take in and exhaust external air. The are intake louvers 4830 is also included in the louvers for the fixing module.

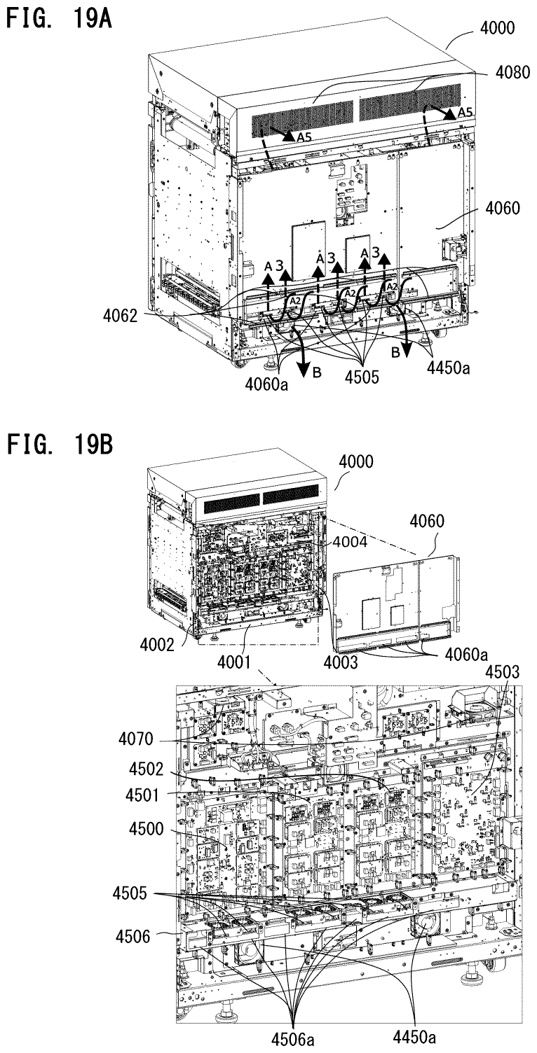

FIG. 19A and FIG. 19B are configuration views for illustrating the fixing module 4000 from which the external electric component module 4800 is disconnected. FIG. 19A is a perspective view for illustrating the fixing module 4000 from the upper rear side, and FIG. 19B is an exploded perspective view for illustrating the fixing module 4000 from the upper rear side, and a partial enlarged view thereof. The fixing module 4000 includes a bottom plate 4001, and a rear right column 4002 and a rear left column 4003 supported by the bottom plate 4001. The rear right column 4002 and the rear left column 4003 are each welded and fixed to the corner of the bottom plate 4001 on the rear side. A rear side plate 4004 is fixed perpendicular to the bottom plate 4001 at a position sandwiched between the rear right column 4002 and the rear left column 4003. A plurality of electric component units is arranged on the rear side of the rear side plate 4004. That is, the electric component unit of the fixing module 4000 is arranged on the external electric component module 4800 side (that is, the rear side) in the crossing direction of crossing with the sheet conveying direction.

The electric component portion provided on the rear side of the fixing module 4000 includes, in a positional relationship similar to that of the drying module 3000, a main control board 4500, a first sub-control board 4501, and a second sub-control board 4502. The fixing module 4000 includes board cooling fans 4505 for cooling those boards, and a separation-shielding duct 4506 for supporting the board cooling fans 4505.

Below the separation-shielding duct 4506 as well, similarly, return path conveyance unit exhaust fans 4450a for ventilating a double-sided printing conveyance path which is provided inside of the fixing module 4000 and through which the sheet is conveyed at the time of double-sided printing are provided. The role of the separation-shielding duct 4506 is similar to the duct 3506 provided in the drying module 3000. Thus, the intake path of the board cooling fan 4505 is also a path passing through the external electric component module 4800 connected to the separation-shielding duct 4506 (air paths A1 (described later), A2, and A3).

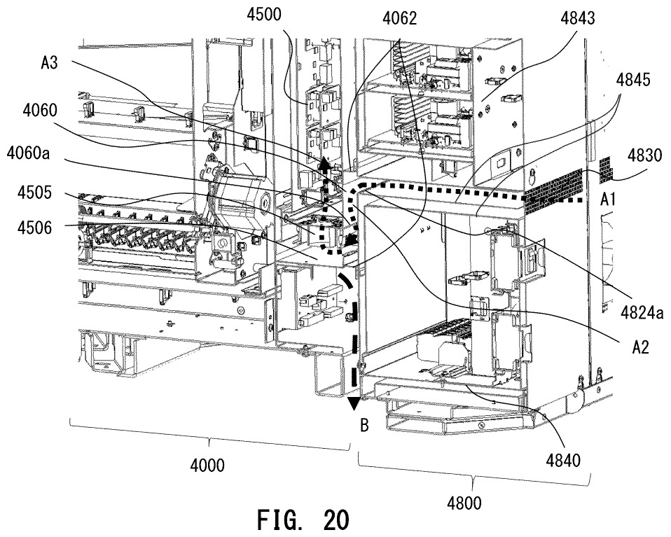

The external electric component module 4800 arranged on the rear side of the fixing module 4000 has a different power supply destination and a partially different function from the external electric component module 3800 of the drying module 3000, and hence is different in internal configuration units. FIG. 20 is an enlarged cross-sectional view for illustrating an air path provided so as to pass through the external electric component module 4800. The air path A1 is formed at a position different in the vertical direction from the entrance opening 4506a (see FIG. 19B) and the inner cover opening 4060a provided on the fixing module 4000 side. This is because, as described above, a unit provided in the external electric component module 4800, in particular, a unit in the lower portion individually includes a protection cover, and an opening for forming an air wind path cannot be formed in the unit.

The intake path of the board cooling fan 4505 passing through the external electric component module 4800 assumes a space between the power cord base and circuit breaker unit 4840 arranged at the lower stage and the DC power supply unit 4843 arranged at the middle stage as a path (air path A1). Unlike the external electric component module 3800 of the drying module 3000, in the external electric component module 4800, a space between the power supply filter unit 4841 and the relay and terminal unit 4842 is narrow, and hence this part is not used as the intake path.

Further, the middle through-path has an intake port close to the exhaust fan of the DC power supply unit 4843, and hence a dedicated through-duct 4845 is provided so as to prevent exhaust air from being circulated inside of the external electric component module 4800. The air path A1 which is the through-path on the right side as viewed from the apparatus rear side assumes a space surrounded by the casings between the power cord base and circuit breaker unit 4840 and the DC power supply unit 4843 as the intake path. Those through-paths are communicated with the intake louver 4830 (see FIG. 18A) provided in the annex rear cover 4825 of the external electric component module 4800 so that external air can be taken in.

The fixing module 4000 side of the air path A1 is connected to the connection portion air path A2 having a configuration similar to that of the drying module 3000, and a path is formed so as to align in position in the vertical direction with the separation-shielding duct 4506 which is the intake port of the board cooling fan 4505. In this manner, the board cooling fan 4505 can take in external air through the air path passing through the external electric component module 4800, and can blow air to cool the main control board 4500, the first sub-control board 4501, and the second sub-control board 4502 (air path A3).

The air blown to the electric component board group flows through, similarly to the drying module 3000, a space shielded by the electric component inner cover 4060 in the vertical direction to the apparatus upper portion. An electric component exhaust fan 4070 (see FIGS. 19A and 19B) of the fixing module 4000 is directed to the apparatus upper side, and hence the air is exhausted to the apparatus rear side through a rear-side louver 4080 in the upper portion of the fixing module 4000 without passing through the external electric component module 4800 (air path A5, see FIG. 19A).

As described above, in an image forming system formed of a plurality of modules, cooling of an internal electric component unit can be performed with an airflow using air supplied from external air having few floating matters. Accordingly, while the cooling effect is maintained, an airflow configuration having high reliability and using intake air with few floating matters can be achieved. In this manner, it is possible to provide, without sacrificing the installation performance and the maintenance performance, the image forming system satisfying the expectations of high reliability, high durability, and long lifetime.

In the description above, the ink-jet recording system 100 adopting the ink-jet system has been used as the image forming system. The image forming system of this embodiment may be configured to form an image by a system other than the ink-jet system, such as an electrophotographic system. In any case, the configuration of this embodiment is effective as long as the image forming system has a configuration which is formed of a plurality of modules and in which another module is arranged on the apparatus rear side.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2024-059674, filed Apr. 2, 2024, and No. 2024-209951, filed Dec. 3, 2024, which are hereby incorporated by reference herein in their entirety.

What is claimed is:

1. An image forming system including a plurality of modules, the image forming system comprising:
a first module;
a second module, the first module and the second module being arranged along a conveying direction in which a sheet in the first module is conveyed;
a first electric component module coupled to the first module, the first electric component module being arranged, with respect to the first module, in a crossing direction that intersects the conveying direction;
a first electric component unit provided in the first module; and
a duct arranged below the first electric component unit in a vertical direction, the duct being configured to guide air for cooling the first electric component unit,
wherein the first electric component module has an intake through which the air is sucked into inside the first electric component module, and
wherein the duct has a duct opening through which the air passes,
wherein a first air path is formed in the first electric component module so that the air sucked through the intake of the first electric component module flows to the duct opening.

2. The image forming system according to claim 1,
wherein the first electric component module includes a cover on a surface facing the first module,
wherein the cover has a cover opening communicated with the intake,
wherein the duct opening and the cover opening are different in positions at a connection portion between the first module and the first electric component module, and
wherein a second air path connecting the duct opening and the cover opening is formed in a space between the first module and the first electric component module, and
wherein the air sucked through the intake of the first electric component module flows to the duct opening via the first air path and the second air path.

3. The image forming system according to claim 2, wherein the duct opening and the cover opening are different in positions in the vertical direction in the surface in which the first module and the first electric component module are in contact with each other.

4. The image forming system according to claim 2,
wherein the first module includes an electric component inner cover on a surface facing the first electric component module,
wherein the electric component inner cover is provided so that a lower portion of the electric component inner cover is in contact with the duct and so as to cover the first electric component unit, and
wherein at least a part of the air second path is formed between the cover and the electric component inner cover.
